(19) United States
(12) Patent Application Publication
(10) Pub. No.: US 2022/0156436 A1
(43) Pub. Date: May 19, 2022

(54) SIMULATION DEVICE, SIMULATION METHOD, AND PROGRAM

(71) Applicant: SUMITOMO HEAVY INDUSTRIES, LTD., Tokyo (JP)

(72) Inventor: Masato Hirota, Kanagawa (JP)

(21) Appl. No.: 17/528,984

(22) Filed: Nov. 17, 2021

(30) Foreign Application Priority Data
Nov. 18, 2020 (JP) 2020-191834

(51) Int. Cl. G06F 30/25

(52) U.S. Cl. CPC G06F 30/25; G06F 2113/08

(57) ABSTRACT

Information for defining a fluid to be analyzed, initial conditions and boundary conditions for analysis, and wall information for defining a shape of a wall surface boundary disposed in an analysis target space are input to an input unit. A processing unit represents the fluid with a plurality of fluid particles and analyzes motions of the plurality of fluid particles on the basis of the information input to the input unit. A contribution of a wall to a motion of each of the plurality of fluid particles is obtained by using the shape of the wall surface boundary and a spatial distribution of the plurality of fluid particles existing near the wall surface boundary, and the motions of the plurality of fluid particles are analyzed on the basis of the obtained contribution of the wall and contributions of other fluid particles for each of the plurality of fluid particles.

### RELATED APPLICATIONS

The content of Japanese Patent Application No. 2020-191834, on the basis of which priority benefits are claimed in an accompanying application data sheet, is in its entire incorporated herein by reference.

### BACKGROUND

### Technical Field

Certain embodiments of the present invention relate to a simulation device, a simulation method, and a program.

### Description of Related Art

A simulation method is known in which a flow field of a fluid is approximated as the motion of a particle system to analyze a behavior of the fluid. This simulation method is called a particle method (SPH method). In the SPH method, a fluid is represented as a plurality of particles. As a method for imposing a wall surface boundary condition in the SPH method, a method of disposing a plurality of virtual particles inside a wall surface boundary is well known in the related art. A method of reproducing a wall surface boundary with polygons instead of virtual particles is well known in the related art.

### SUMMARY

According to one aspect of the invention, there is provided a simulation device that analyzes a flow of a fluid by using a particle method, the simulation device including an input unit to which information for defining the fluid to be analyzed, initial conditions and boundary conditions for analysis, and wall information for defining a shape of a wall surface boundary disposed in a space that is an analysis target are input; and a processing unit that represents the fluid with a plurality of fluid particles and analyzes motions of the plurality of fluid particles on the basis of the information input to the input unit. The processing unit obtains a contribution of a wall to a motion of each of the plurality of fluid particles by using the shape of the wall surface boundary and a spatial distribution of the plurality of fluid particles existing near the wall surface boundary, and analyzes the motions of the plurality of fluid particles on the basis of the obtained contribution of the wall and contributions of other fluid particles for each of the plurality of fluid particles.

According to another aspect of the invention, there is provided a simulation method using a particle method of analyzing a flow of a fluid by representing the fluid with a plurality of fluid particles and analyzing motions of the fluid particles, the simulation method including defining a shape of a wall surface boundary of a wall disposed in an analysis space; obtaining a contribution of the wall to a motion of each of the plurality of fluid particles by using a shape of the wall surface boundary and a spatial distribution of the plurality of fluid particles existing near the wall surface boundary; and analyzing the motions of the plurality of fluid particles on the basis of the obtained contribution of the wall and contributions of other fluid particles for each of the plurality of fluid particles.

According to still another aspect of the invention, there is provided a computer readable medium storing a program that causes a computer to execute a process for analyzing a flow of a fluid by using a particle method, the process including acquiring information for defining the fluid to be analyzed, initial conditions and boundary conditions for analysis, and wall information for defining a shape of a wall surface boundary disposed in a space that is an analysis target; representing the fluid with a plurality of fluid particles and analyzing motions of the plurality of fluid particles on the basis of the acquired information; obtaining a contribution of a wall to a motion of each of the plurality of fluid particles by using the shape of the wall surface boundary and a spatial distribution of the plurality of fluid particles existing near the wall surface boundary; and analyzing the motions of the plurality of fluid particles on the basis of the obtained contribution of the wall and contributions of other fluid particles for each of the plurality of fluid particles.

### BRIEF DESCRIPTION OF THE DRAWINGS

FIG. 1 is a perspective view illustrating an example of an analysis model.

FIG. 2 is a schematic diagram illustrating fluid particles near a wall surface boundary and virtual particles that reproduce the wall surface boundary.

FIGS. 3A and 3B are schematic diagrams illustrating a positional relationship between fluid particles, virtual particles, and a wall surface boundary, and velocity vectors.

FIG. 4 is a schematic diagram illustrating a positional relationship between fluid particles and a wall surface boundary of an analysis model used in the present embodiment.

FIGS. 5A and 5B are schematic diagrams illustrating a positional relationship between fluid particles, virtual particles, and wall surface boundary, and velocity vectors.

FIG. 6 is a block diagram of a simulation device according to the present embodiment.

FIG. 7 is a flowchart illustrating a procedure in a simulation method according to an embodiment.

FIG. 8 is a schematic diagram illustrating an analysis model for simulation performed to check the accuracy of the simulation method according to the embodiment.

FIG. 9 is a graph illustrating a relationship between a drag coefficient acting on a cylinder, obtained from a simulation result, and the Reynolds number.

### DETAILED DESCRIPTION

In the method of reproducing a wall surface boundary by disposing a plurality of virtual particles, it is difficult to properly disposing the virtual particles in a case where a shape of the wall surface boundary is complicated or the wall surface boundary is deformed or moved.

In the method of reproducing a wall surface boundary with polygons, it is assumed that a plurality of wall particles are uniformly arranged in a plane perpendicular to the perpendicular line drawn from each of the plurality of particles (fluid particles) representing the fluid to the wall surface boundary, and a weighting function or a gradient of the weighting function is calculated as a function of a distance from the fluid particle to the wall. As described above, it is premised that the shape of the wall surface boundary is almost flat, and in a case where a wall having a curvature exists, the accuracy of the analysis is lowered.

It is desirable to provide a simulation device, a simulation method, and a program capable of performing highly accurate analysis without being restricted by a geometric shape of a wall in a flow field in simulation using an SPH method.

A contribution of the wall to a motion of each of the plurality of fluid particles is obtained by using the shape of the wall surface boundary and a spatial distribution of the plurality of fluid particles existing near the wall surface boundary, and thus highly accurate analysis can be performed without being restricted by a geometric shape of the wall in a flow field. Since it is not necessary to dispose a plurality of virtual particles that reproduce the wall surface boundary, it is possible to easily simulate a flow field having a wall surface boundary.

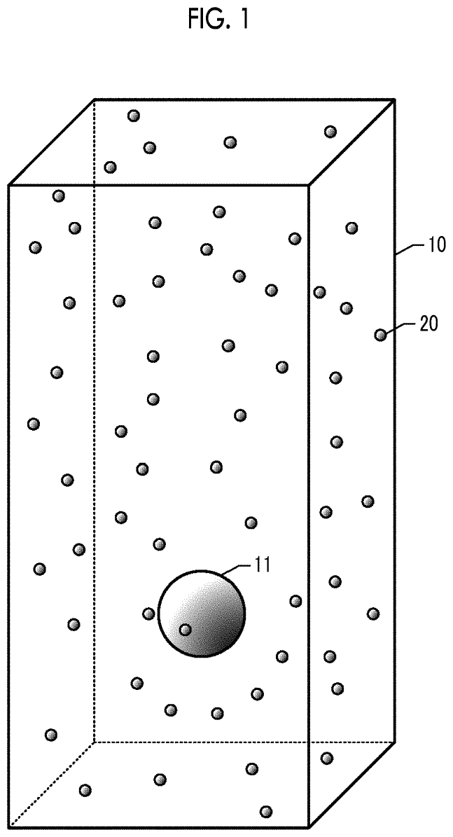

Prior to description of embodiments of the present invention, a simulation method of the related art using an SPH method will be briefly described with reference to FIGS. 1 to 3B. In the SPH method, a kernel function is disposed at each position of a plurality of fluid particles representing a fluid, and a spatial distribution of fluid variables is represented as a superposition of the kernel functions.

FIG. 1 is a perspective view illustrating an example of an analysis model. A plurality of fluid particles 20 representing a fluid are disposed in a rectangular analysis space 10, a force acting on each of the fluid particles 20 is obtained, and a governing equation of the fluid is numerically solved, so that behaviors of the fluid particles 20 are analyzed. A wall having a wall surface boundary 11 is disposed in the analysis space 10.

A typical governing equation for a fluid used in the SPH method is expressed by the following equations.

$$\begin{matrix} \frac{d {ρ}_{i}}{dt} = - {ρ}_{i} {\sum }_{j} \frac{{m}_{j}}{{ρ}_{j}} ( {v}_{j} - {v}_{i} ) \cdot {∇}_{i} {W}_{ij} & ( 1 ) \\ \frac{{dv}_{i}}{dt} = - \frac{1}{{ρ}_{i}} {\sum }_{j} \frac{{m}_{j}}{{ρ}_{j}} ( {p}_{j} + {p}_{i} ) {∇}_{i} {W}_{ij} + 2 ( d + 2 ) \frac{μ}{{ρ}_{i}} {\sum }_{j} \frac{{m}_{j}}{{ρ}_{j}} ( {v}_{j} - {v}_{i} ) \cdot \frac{{r}_{j} - {r}_{i}}{{‖ {r}_{j} - {r}_{i} ‖}^{2}} {∇}_{i} {W}_{ij} & ( 2 ) \\ \frac{{dr}_{i}}{dt} = {v}_{i} & ( 3 ) \\ {p}_{i} = {c}_{0}^{2} ( {ρ}_{i} - {ρ}_{0} ) & ( 4 )\end{matrix}$$

Here, mᵢ and ρᵢ respectively represent the mass and a density of the i-th fluid particle 20. pᵢ, vᵢ, and rᵢ respectively indicate a pressure, a velocity vector (hereinafter, simply referred to as a “velocity” in some cases), and a position vector (hereinafter, simply referred to as “position” in some cases) of the i-th fluid particle 20. c₀ is the speed of sound, ρ₀ is a reference density, and μ is a viscosity coefficient. Further, d indicates the number of dimensions of the space. Wᵢⱼ is a kernel function between the i-th fluid particle 20 and the j-th fluid particle 20. ∇ᵢWᵢⱼ is a vector representing a derivative of a kernel function Wᵢⱼ at the position of the i-th fluid particle 20.

The kernel function Wᵢⱼ is a function of only a distance rᵢⱼ between the i-th particle and the j-th particle, and for example, the following function may be used.

$$W ( r ) = \frac{1}{4 π {h}^{3}} [ {( 2 - r )}^{3} - 4 {( 1 - r )}^{3} ] ( 0 \leq r < h ) \\ W ( r ) = \frac{1}{4 π {h}^{3}} {( 2 - r )}^{3} ( h \leq r < 2 h ) \\ W ( r ) = 0 ( r \geq 2 h ) \qquad ( 5 )$$

Here, h indicates a kernel width, and may be set to a value similar to, for example, an average particle interval in an initial state. The fluid particle 20 may be regarded as a sphere having the diameter h.

Equation (1) is an equation by discretizing a continuity equation for a fluid, and Equation (2) is an equation of motion that the fluid particle 20 follows. The first term on the right side of Equation (2) corresponds to a force due to a pressure gradient, and the second term on the right side corresponds to a force due to a viscosity of the fluid.

In a case where the wall surface boundary 11 exists in the flow field, a plurality of virtual particles are disposed inside the wall surface boundary 11 in the related art.

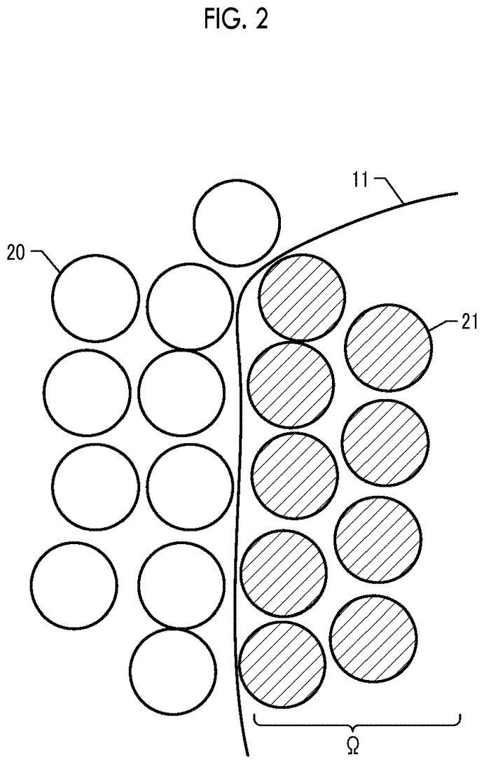

FIG. 2 is a schematic diagram illustrating the fluid particles 20 near the wall surface boundary 11 and virtual particles 21 reproducing the wall surface boundary 11. A plurality of fluid particles 20 are disposed outside the wall surface boundary 11, and a plurality of virtual particles 21 are disposed inside thereof. In FIG. 2, the virtual particles 21 are hatched. Considering that the fluid particle 20 and the virtual particle 21 interact with each other, Equations (1) and (2) are rewritten as follows.

$$\begin{matrix} \frac{d {ρ}_{i}}{dt} = - {ρ}_{i} {\sum }_{j ∈ Ω} \frac{{m}_{i}}{{ρ}_{j}} ( {v}_{j} - {v}_{i} ) \cdot {∇}_{i} {W}_{ij} - {ρ}_{i} {\sum }_{j ∉ Ω} \frac{{m}_{j}}{{ρ}_{j}} ( {v}_{j} - {v}_{i} ) \cdot {∇}_{i} {W}_{ij} & ( 6 ) \\ \frac{{dv}_{i}}{dt} = - \frac{1}{{ρ}_{i}} {\sum }_{j ⋐ Ω} \frac{{m}_{j}}{{ρ}_{j}} ( {p}_{j} + {p}_{i} ) {∇}_{i} {W}_{ij} + 2 ( d + 2 ) \frac{μ}{{ρ}_{i}} {\sum }_{j ∈ Ω} \frac{{m}_{j}}{{ρ}_{j}} ( {v}_{j} - {v}_{i} ) \cdot \frac{{r}_{j} - {r}_{i}}{{‖ {r}_{j} - {r}_{i} ‖}^{2}} {∇}_{i} {W}_{ij} - \frac{1}{{ρ}_{i}} {\sum }_{j ∉ Ω} \frac{{m}_{j}}{{ρ}_{j}} ( {ρ}_{j} + {p}_{i} ) {∇}_{i} {W}_{ij} + 2 ( d + 2 ) \frac{μ}{{ρ}_{i}} {\sum }_{j ∉ Ω} \frac{{m}_{j}}{{ρ}_{j}} ( {v}_{j} - {v}_{i} ) \cdot \frac{{r}_{j} - {r}_{i}}{{‖ {r}_{j} - {r}_{i} ‖}^{2}} {∇}_{i} {W}_{ij} & ( 7 )\end{matrix}$$

Ω attached to the sigma symbol in Equation (6) and Equation (7) indicates a set of virtual particles 21 disposed inside the wall surface boundary 11. That is, the first term on the right side of Equation (6) and the first and second terms on the right side of Equation (7) represent a total amount of contributions from the plurality of virtual particles 21 inside the wall surface boundary 11 to the i-th fluid particle 20, and the second term on the right side of Equation (6) and the third and fourth terms on the right side of Equation (7) represent a total amount of contributions from the plurality of fluid particles 20 to the i-th fluid particle 20.

When an amount of contributions from the virtual particles 21 is calculated, values of the mass mⱼ, the density ρⱼ, the pressure pⱼ, and the velocity vector vⱼ of the virtual particle 21 are required to be set depending on boundary conditions. When a non-slip condition (zero flow velocity on the wall surface) at the wall surface boundary 11 is imposed, the mass mⱼ, the density ρⱼ, and the pressure pⱼ are given by the following equation.

mⱼ=mᵢ

ρⱼ=ρᵢ

pⱼ=pᵢ (8)

The velocity vector vⱼ of the continuity equation (6) is given by the following equation.

$${v}_{j} \cdot τ = {v}_{i} \cdot τ \\ {v}_{j} \cdot n = - {v}_{i} \frac{{s}_{j}}{{s}_{i}} \cdot n \qquad ( 9 )$$

The velocity vector vⱼ of the equation of motion (7) is given by the following equation.

$${v}_{j} \cdot τ = - {v}_{i} \frac{{s}_{j}}{{s}_{i}} \cdot τ \\ {v}_{j} \cdot n = {v}_{i} \cdot n \qquad ( 10 )$$

Here, τ and n are respectively a unit vector in a tangential direction of the wall surface boundary 11 and a unit vector in a normal direction at a position of the wall surface boundary 11 where a distance to the i-th fluid particle 20 is the minimum. sᵢ indicates the shortest distance between the i-th fluid particle 20 and the wall surface boundary 11, and sⱼ indicates the shortest distance between the j-th virtual particle 21 and the wall surface boundary 11.

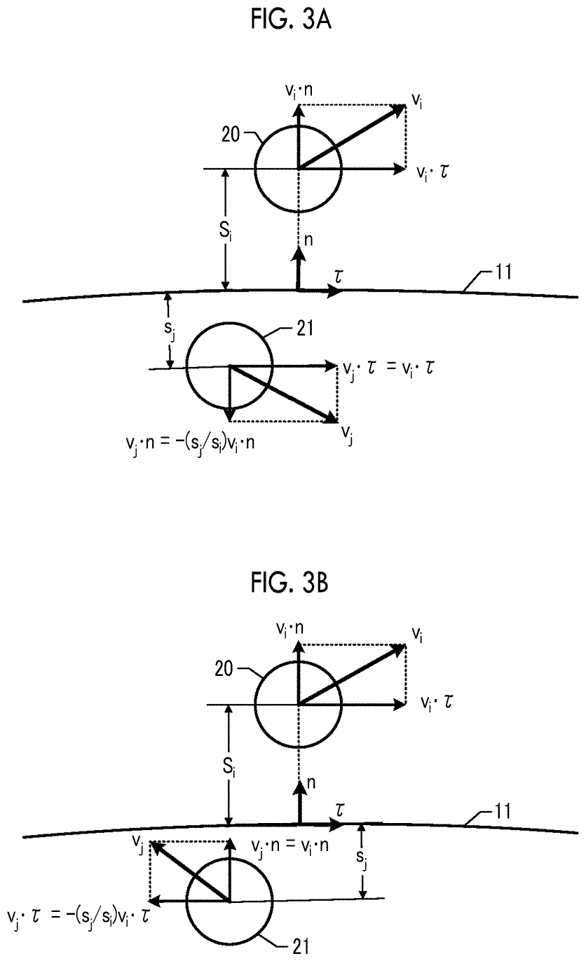

Next, the physical meanings of Equations (9) and (10) will be described with reference to FIGS. 3A and 3B. FIGS. 3A and 3B are schematic diagrams illustrating a positional relationship between the fluid particle 20, the virtual particle 21, and the wall surface boundary 11, and a velocity vector. FIG. 3A illustrates a velocity vector having a relationship of Equation (9), and FIG. 3B illustrates a velocity vector having the relationship of Equation (10).

As illustrated in FIG. 3A, Equation (9) means that a magnitude and an orientation of a component in the tangential direction of the velocity vector vⱼ of the j-th virtual particle 21 are made equal to a magnitude and an orientation of a component in the tangential direction of the velocity vector vᵢ of the i-th fluid particle i. Equation (9) also means that an orientation of a component in the normal direction of the velocity vector vⱼ of the j-th virtual particle 21 is opposite to an orientation of a component in the normal direction of the velocity vector vᵢ of the i-th fluid particle i, and a magnitude of the component in the normal direction is made equal to a magnitude obtained by multiplying a magnitude of the component in the normal direction of the velocity vector vᵢ of the i-th fluid particle i by (sⱼ/sᵢ).

As illustrated in FIG. 3B, Equation (10) means that a magnitude and an orientation of a component in the normal direction of the velocity vector vⱼ of the j-th virtual particle 21 are made equal to a magnitude and an orientation of a component in the normal direction of the velocity vector vᵢ of the i-th fluid particle i. Equation (10) also means that an orientation of a component in the tangential direction of the velocity vector vⱼ of the j-th virtual particle 21 is opposite to an orientation of a component in the tangential direction of the velocity vector vᵢ of the i-th fluid particle i, and a magnitude of the component in the tangential direction is made equal to a magnitude obtained by multiplying a magnitude of the component in the tangential direction of the velocity vector vᵢ of the i-th fluid particle i by (sⱼ/sᵢ).

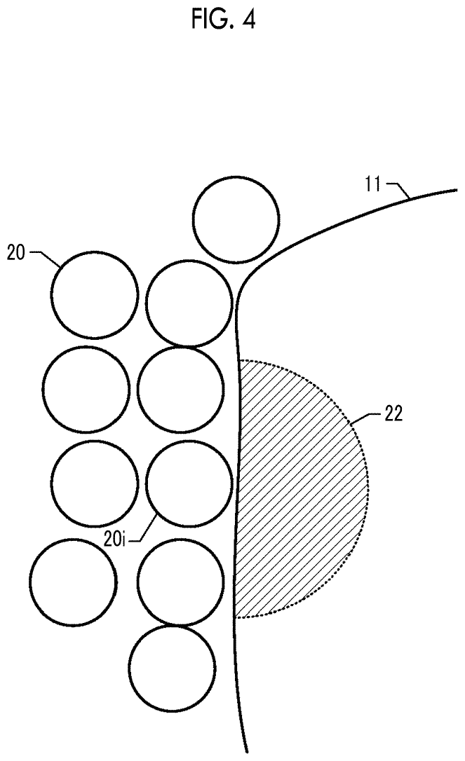

Next, an embodiment of the present invention will be described with reference to FIGS. 4 to 7.

FIG. 4 is a schematic diagram illustrating a positional relationship between fluid particles 20 and a wall surface boundary 11 of an analysis model used in the present embodiment. A plurality of fluid particles 20 outside the wall surface boundary 11 are disposed, but a plurality of virtual particles inside wall surface boundary 11 are not disposed. When an amount of contribution from the wall surface boundary 11 to the i-th fluid particle 20 is obtained, a virtual wall 22 that reproduces the wall surface boundary 11 is disposed inside the wall surface boundary 11 in the vicinity of the i-th fluid particle 20. The virtual wall 22 is not a wall that is always disposed in a space of the analysis model, but is provisionally disposed for each fluid particle 20 when an amount of contribution from the wall surface boundary 11 to each of the fluid particles 20 is computed.

First, an amount of contributions from the plurality of virtual particles 21 (FIG. 2) are replaced with an amount of contribution from one virtual wall 22, and the continuity equation (6) and the equation of motion (7) are rewritten as follows.

$$\begin{matrix} \frac{d {ρ}_{i}}{dt} = - {ρ}_{i} \frac{{m}_{w}}{{ρ}_{w}} ( {v}_{w} - {v}_{i} ) \cdot {∇}_{i} {W}_{iw} - {ρ}_{i} {\sum }_{j ∉ Ω} \frac{{m}_{j}}{{ρ}_{j}} ( {v}_{j} - {v}_{i} ) \cdot {∇}_{i} {W}_{ij} & ( 11 ) \\ \frac{{dv}_{i}}{dt} = - \frac{1}{{ρ}_{i}} \frac{{m}_{w}}{{ρ}_{w}} ( {p}_{w} + {p}_{i} ) {∇}_{i} {W}_{iw} + 2 ( d + 2 ) \frac{μ}{{ρ}_{i}} \frac{{m}_{w}}{{ρ}_{w}} ( {v}_{w} - {v}_{i} ) \cdot \frac{{r}_{w} - {r}_{i}}{{‖ {r}_{w} - {r}_{i} ‖}^{2}} {∇}_{i} {W}_{iw} - \frac{1}{{ρ}_{i}} {\sum }_{j ∉ Ω} \frac{{m}_{j}}{{ρ}_{j}} ( {ρ}_{j} + {p}_{i} ) {∇}_{i} {W}_{ij} + 2 ( d + 2 ) \frac{μ}{{ρ}_{i}} {\sum }_{j ∉ Ω} \frac{{m}_{j}}{{ρ}_{j}} ( {v}_{j} - {v}_{i} ) \cdot \frac{{r}_{j} - {r}_{i}}{{‖ {r}_{j} - {r}_{i} ‖}^{2}} {∇}_{i} {W}_{ij} & ( 12 )\end{matrix}$$

Here, m_{w}, ρ_{w}, p_{w}, v_{w}, and r_{w} are respectively the mass, a density, a pressure, a velocity, and a position given to the virtual wall 22.

From the interpolation formula of the derivative of the kernel function for any physical quantity A depending on the position rᵢ, the following equation is established.

$$\begin{matrix}∇ A ( {r}_{i} ) = {\sum }_{j} \frac{{m}_{j}}{{ρ}_{j}} {A}_{j} {∇}_{i} {W}_{ij} \\ = {\sum }_{j ∈ Ω} \frac{{m}_{j}}{{ρ}_{j}} {A}_{j} {∇}_{i} {W}_{ij} + {\sum }_{j ∉ Ω} \frac{{m}_{j}}{{ρ}_{j}} {A}_{j} {∇}_{i} {W}_{ij}\end{matrix} \qquad ( 13 )$$

Here, A(rᵢ) is a value at any position rᵢ in the space of the physical quantity A, and Aᵢ is a value of the physical quantity A of the i-th particle. Equation (13) represents that a sum of the physical quantity Aⱼ obtained by applying the derivative of the kernel function to the j-th particle existing near the position rᵢ is computed, and thus a derivative of the physical quantity A(rᵢ) at the position rᵢ is obtained.

When “1” is assigned to the physical quantity A in Equation (13), the derivative of “1” is zero, and thus the following equation is derived.

$$0 = {\sum }_{j} \frac{{m}_{j}}{{ρ}_{j}} 1 {∇}_{i} {W}_{ij} = {\sum }_{j ∈ Ω} \frac{{m}_{j}}{{ρ}_{j}} {∇}_{i} {W}_{ij} + {\sum }_{j ∉ Ω} \frac{{m}_{j}}{{ρ}_{j}} {∇}_{i} {W}_{ij} \qquad ( 14 )$$

Equation (14) may be rewritten as follows.

$${\sum }_{j ∈ Ω} \frac{{m}_{j}}{{ρ}_{j}} {∇}_{i} {W}_{ij} = - {\sum }_{j ∉ Ω} \frac{{m}_{j}}{{ρ}_{j}} {∇}_{i} {W}_{ij} \qquad ( 15 )$$

Summarizing the left side of Equation (15) as an amount of contribution from the virtual wall 22, the following equation is derived.

$$\frac{{m}_{w}}{{ρ}_{w}} {∇}_{i} {W}_{iw} = - {\sum }_{j ∉ Ω} \frac{{m}_{j}}{{ρ}_{j}} {∇}_{i} {W}_{ij} \qquad ( 16 )$$

Equation (16) means that an amount of contribution from the virtual wall 22 when computing the derivative of the kernel function can be estimated from a spatial distribution of a plurality of fluid particles 20 existing near the i-th fluid particle 20. When the terms including m_{w}, ρ_{w}, and ∇ᵢW_{iw} in the continuity equation (11) and the equation of motion (12) are replaced with the right side of Equation (16), only parameters to be determined in order to numerically solve the continuity equation (11) and the equation of motion (12) are a pressure p_{w}, a velocity v_{w}, and a position r_{w}.

The pressure p_{w} is given by the following equation in the same manner as in Equation (8).

p_{w}=pᵢ (7)

The velocity v_{w} in the continuity equation (11) is given by the following equation in the same manner as in Equation (9).

v_{w}·τ=vᵢ·τ

$${v}_{w} \cdot n = - {v}_{i} \frac{{s}_{w}}{{s}_{i}} \cdot n \qquad ( 18 )$$

The velocity v_{w} in the equation of motion (12) is given by the following equation in the same manner as in Equation (10).

$${v}_{w} \cdot τ = - {v}_{i} \frac{{s}_{w}}{{s}_{i}} \cdot τ \\ {v}_{w} \cdot n = {v}_{i} \cdot n \qquad ( 19 )$$

Here, s_{w} indicates a distance from the virtual wall 22 (FIG. 4) to the wall surface boundary 11, and when the position r_{w} of the virtual wall 22 is determined, the distance s_{w} is also determined.

Next, the position r_{w} of the virtual wall 22 will be described. In the present embodiment, the position r_{w} is given by the following equation.

$${r}_{w} = {r}_{i} - ( {s}_{i} + \frac{h}{2} ) n \qquad ( 20 )$$

Here, h indicates a kernel width of the fluid particle 20, that is, a particle diameter. The kernel width h in Equation (20) is equal to the kernel width h in Equation (5).

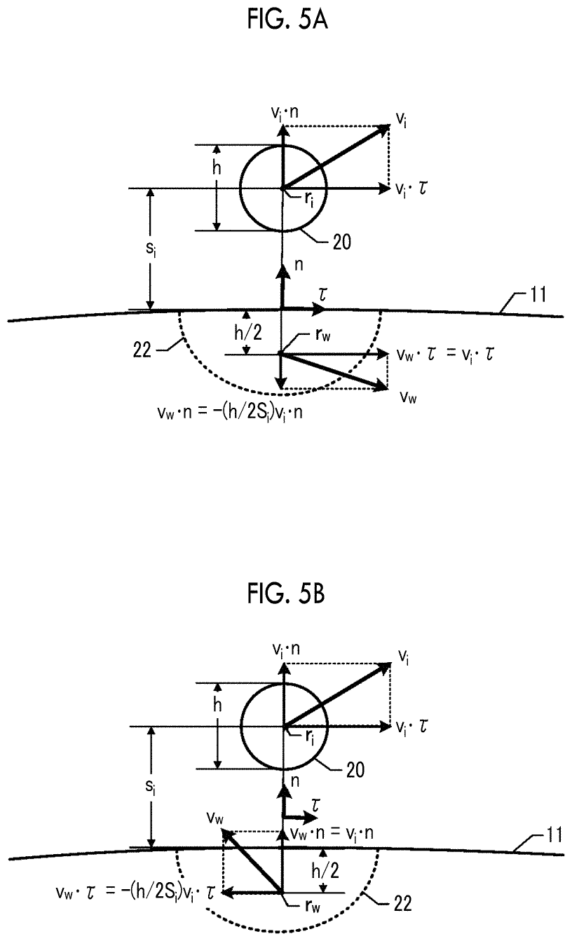

Next, the physical meanings of Equations (18) to (20) will be described with reference to FIGS. 5A and 5B. FIGS. 5A and 5B are schematic diagrams illustrating a positional relationship between the wall surface boundary 11 and the virtual wall 22, and a velocity. FIG. 5A illustrates a velocity having a relationship in Equation (18), and FIG. 5B illustrates a velocity having a relationship in Equation (19).

As illustrated in FIGS. 5A and 5B, the position r_{w} of the virtual wall 22 when numerically solving the continuity equation (11) and the equation of motion (12) employs a position that is located on an extension line of a perpendicular line drawn from the computation target i-th fluid particle 20 to the wall surface boundary 11 and at which a distance from the wall surface boundary 11 is made equal to ½ (that is, a radius) of the kernel width h of the fluid particles 20. In this case, the distance s_{w} is given by the following equation.

$${s}_{w} = \frac{h}{2} \qquad ( 21 )$$

The velocity v_{w} of the virtual wall 22 in the continuity equation (11) and the equation of motion (12) is determined on the basis of the velocity vᵢ of the computation target i-th fluid particle 20 and the distance sᵢ from the i-th fluid particle 20 to the wall surface boundary 11 by using respective Equations (18) and (19).

For example, as illustrated in FIG. 5A, an orientation and a magnitude of the tangential component of the velocity v_{w} of the virtual wall 22 in the continuity equation (11) are made equal to an orientation and a magnitude of the velocity vector vᵢ in the tangential component of the computation target i-th fluid particle 20. An orientation of the normal component of the velocity vector v_{w} in the continuity equation (11) is opposite to an orientation of the normal component of the velocity vector vᵢ. When the distance sᵢ is made equal to h/2, that is, the i-th fluid particle 20 is in contact with the wall surface boundary 11, a magnitude of the normal component of the velocity v_{w} is made equal to a magnitude of the normal component of the velocity vᵢ. As the i-th fluid particle 20 becomes farther from the wall surface boundary 11, the magnitude of the normal component of the velocity v_{w} is reduced in inverse proportion to the distance sᵢ.

For example, as illustrated in FIG. 5B, an orientation of the tangential component of the velocity v_{w} of the virtual wall 22 in the equation of motion (12) is opposite to an orientation of the tangential component of the velocity vᵢ of the i-th fluid particle 20. When the distance sᵢ is made equal to h/2, that is, the i-th fluid particle 20 is in contact with the wall surface boundary 11, the magnitude of the tangential component of the velocity v_{w} is made equal to the magnitude of the tangential component of the velocity vᵢ. As the i-th fluid particle 20 becomes farther from the wall surface boundary 11, the magnitude of the tangential component of the velocity v_{w} is reduced in inverse proportion to the distance sᵢ. The orientation and the magnitude of the normal component of the velocity v_{w} of the virtual wall 22 in the equation of motion (12) are made equal to the orientation and the magnitude of the normal component of the velocity vᵢ of the i-th fluid particle 20.

A component in the normal direction of a velocity difference v_{w}-vᵢ of the second term on the right side of the equation of motion (12) becomes zero. A component in the tangential direction of a position difference r_{w}-rᵢ is zero. Therefore, the inner product of both is always zero. In other words, a contribution of the viscous force from the virtual wall 22 becomes zero. In order to avoid this, the second term on the right side of the equation of motion (12) is replaced with the following expression.

$$2 \frac{μ}{{ρ}_{i}} \frac{{m}_{w}}{{ρ}_{w}} \frac{{v}_{w} - {v}_{i}}{‖ {r}_{w} - {r}_{i} ‖} ( \frac{{r}_{w} - {r}_{i}}{‖ {r}_{w} - {r}_{i} ‖} \cdot {∇}_{i} {W}_{iw} ) \qquad ( 22 )$$

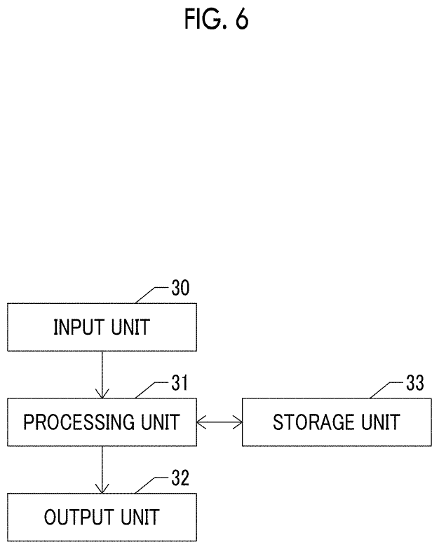

FIG. 6 is a block diagram of the simulation device according to the present embodiment. The simulation device according to the embodiment includes an input unit 30, a processing unit 31, an output unit 32, and a storage unit 33. Simulation conditions and the like are input from the input unit 30 to the processing unit 31. Various commands are input from an operator to the input unit 30. The input unit 30 includes, for example, a communication device, a removable media reading device, a keyboard, a pointing device, and the like.

The processing unit 31 executes simulation according to the SPH method on the basis of the input simulation conditions and commands. A simulation result is output to the output unit 32. The simulation result includes information indicating a state of a particle of the particle system which is a simulation target, a temporal change of a physical quantity of the particle system, and the like. The processing unit 31 includes, for example, a central processing unit (CPU) of a computer. A program for causing a computer to execute the simulation according to the SPH method is stored in the storage unit 33. The output unit 32 includes a communication device, a removable media writing device, a display, and the like.

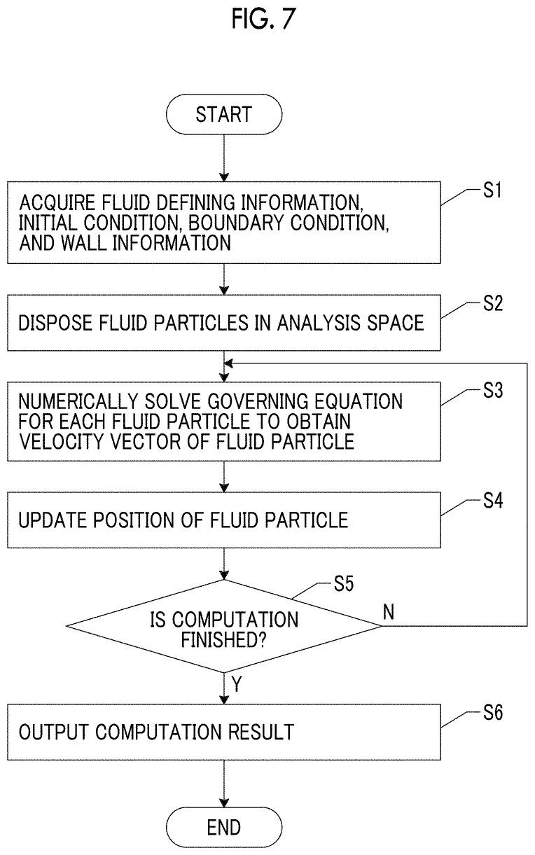

FIG. 7 is a flowchart illustrating the procedure of the simulation method according to the embodiment.

First, the user inputs information for defining a simulation target fluid, initial conditions, boundary conditions, wall information, and the like as simulation conditions from the input unit 30. The processing unit 31 acquires these simulation conditions via the input unit 30 (step S1). The information for defining the simulation target fluid includes physical property values such as a density and a viscosity of the fluid. The initial conditions include information for disposing a plurality of fluid particles 20 in the analysis space 10 (FIG. 1), information for designating an initial velocity of the fluid particle 20, and the like. The boundary conditions include information for designating a shape and a size of the analysis space 10. The wall information includes information for defining a geometric shape and a position of the wall surface boundary 11 disposed inside the analysis space 10.

The processing unit 31 disposes a plurality of fluid particles 20 (FIG. 1) in the analysis space 10 on the basis of the input initial conditions (step S2). The initial velocity is applied to the disposed fluid particle 20.

Next, the processing unit 31 numerically solves the governing equations (11) and (12) of the fluid for each of the fluid particles 20, and thus obtains the velocity vᵢ of the fluid particle 20 in the next state after the time step has passed (step S3). In this case, Equation (16) is assigned to the governing equations (11) and (12), and values obtained by using Equations (17) to (20) are applied to the position r_{w}, velocity v_{w}, and the pressure p_{w} related to the virtual wall 22.

Thereafter, the respective positions rᵢ of the plurality of fluid particles 20 are updated on the basis of the respective velocities vᵢ of the plurality of fluid particles 20 obtained in step S3 (step S4). The position rᵢ of the fluid particle 20 is temporally developed by repeatedly performing steps S3 and S4 until a computation finishing condition is satisfied (step S5).

When the computation is finished, the processing unit 31 outputs the computation result to the output unit 32 (step S6). For example, the processing unit 31 displays, on the output unit 32, the position and the velocity of the fluid particle 20 obtained through the analysis and the shape of the wall surface boundary 11 defined by the input wall information as images in a recognizable manner.

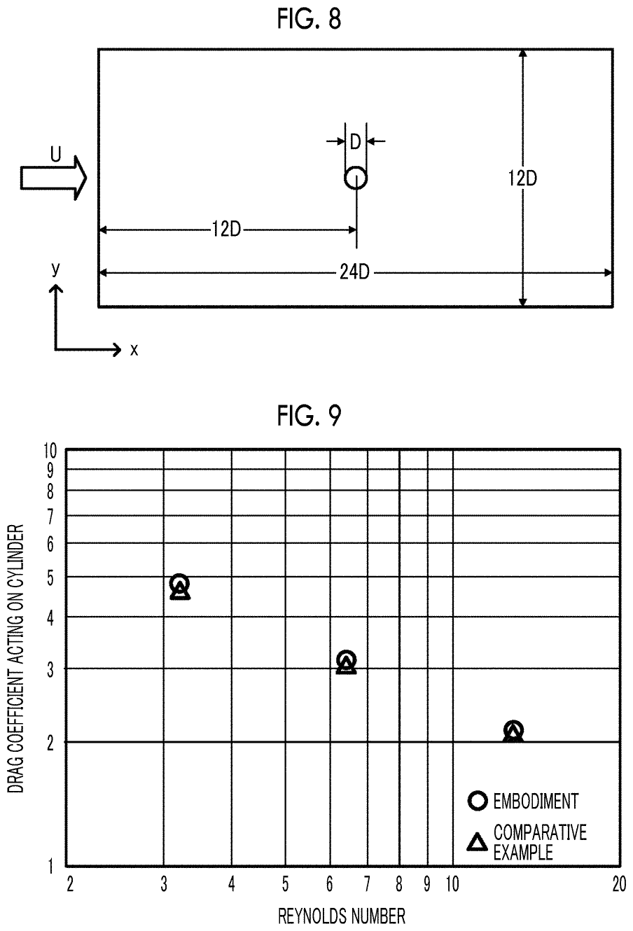

In order to check that a highly accurate analysis result can be obtained in the simulation method according to the embodiment, simulation was actually performed by using the method according to the embodiment and a method according to a comparative example. Next, results of this simulation will be described with reference to FIGS. 8 and 9.

FIG. 8 is a schematic diagram illustrating an analysis model for simulation performed to check the accuracy of the simulation method according to the embodiment. An analysis space for the simulation was made two-dimensional, and a flow field around a cylinder was simulated. The analysis space was a rectangle long in an x direction, and the cylinder was disposed at the center of the analysis space. A length of the long side of the analysis space was set to 24D, a length of the short side was set to 12D, and a diameter of the cylinder was set to D. The kernel width h of the fluid particle was set to D/12, and a plurality of fluid particles were disposed at equal intervals with the interval h. One short side of the analysis space was used as an inflow boundary, and fluid particles were caused to flow into the analysis space from the inflow boundary at a uniform velocity U. Cyclic boundary conditions were imposed on the long sides of the analysis space. As an initial condition for the fluid particle, the uniform velocity U in the x direction was applied to each fluid particle.

The simulation was performed under three conditions that the Reynolds number Re of which a representative velocity is the uniform velocity U is 3.2, 6.4, and 12.8. A time t in the initial state was set to zero, the time was developed to the dimensionless time tU/D=15, and a time average of a drag coefficient acting on the cylinder was measured from the dimensionless time tU/D=10 to 15.

FIG. 9 is a graph illustrating a relationship between the drag coefficient acting on the cylinder, obtained from simulation results, and the Reynolds number. A horizontal axis represents the Reynolds number Re, and a vertical axis represents the drag coefficient. A circled symbol in the graph indicates the drag coefficient obtained by using the simulation method according to the present embodiment, and a triangular symbol indicates the drag coefficient obtained by using the simulation method according to the comparative example. In the comparative example, a plurality of virtual particles 21 (FIG. 2) that reproduce the cylinder were disposed, and analysis was performed by using the governing equations (6) and (7).

As illustrated in FIG. 9, the analysis results obtained by using the simulation method according to the embodiment almost match the analysis results obtained by using the simulation method according to the comparative example. According to the simulation method of the embodiment, it was confirmed that it is possible to simulate a flow field around an object with the same accuracy as the analysis accuracy of the simulation method of the comparative example in which a wall surface boundary is reproduced by a plurality of virtual particles.

Next, the superior effect of the embodiment as compared with the simulation method of the comparative example will be described.

In a case where the simulation method of the comparative example is used, as illustrated in FIG. 2, an operator is required to dispose a plurality of virtual particles 21 along the wall surface boundary 11 as a pre-simulation step. This work is relatively easy in a case where the wall surface boundary 11 has a shape that can be mathematically described, such as the cylinder illustrated in FIG. 8. However, in a case where a shape of the wall surface boundary 11 is complicated and cannot be mathematically described, it is difficult to appropriately dispose a plurality of virtual particles 21 (FIG. 2) along the wall surface boundary 11. In most cases, a shape of the wall surface boundary 11 used for practical analysis cannot be described mathematically and is given by CAD data or the like. Every time a shape of the wall surface boundary 11 that is an analysis target changes, the operator is required to perform the work of disposing the virtual particles 21 that reproduce the wall surface boundary 11.

In the simulation method according to the embodiment, it is not necessary to dispose a plurality of virtual particles 21 (FIG. 2) that reproduce the wall surface boundary 11. In the embodiment, as shown in Equation (16), when the governing equation for the fluid is solved, an amount of contribution from the wall surface boundary 11 to the fluid particle 20 is estimated from a spatial distribution of other fluid particles 20. As described with reference to FIGS. 5A and 5B, the position r_{w} and the velocity v_{w} of the virtual wall 22 are obtained from a position of the i-th fluid particle 20 that is a computation target and a shape of the wall surface boundary 11. In above-described way, the governing equations (11) and (12) can be solved by using information for defining a position and a shape of the wall surface boundary 11. Thus, even when a shape of the wall surface boundary 11 is complicated, a position and a shape of the wall surface boundary 11 can be easily reflected in simulation computation.

In the embodiment, since it is not necessary to dispose a plurality of virtual particles 21 that reproduce the wall surface boundary 11, it is possible to improve the work efficiency of an operator. In a case where a flow field is analyzed by changing a shape of an object in various ways in order to optimize a shape of the object (a shape of the wall surface boundary) disposed in the flow field, it is possible to achieve a particularly remarkable effect by using the simulation method according to the embodiment.

The present invention is not limited to the above embodiment. For example, it will be obvious to those skilled in the art that various changes, improvements, combinations, and the like are possible.

It should be understood that the invention is not limited to the above-described embodiment, but may be modified into various forms on the basis of the spirit of the invention. Additionally, the modifications are included in the scope of the invention.

What is claimed is:

1. A simulation device that analyzes a flow of a fluid by using a particle method, the simulation device comprising:
an input unit to which information for defining the fluid to be analyzed, initial conditions and boundary conditions for analysis, and wall information for defining a shape of a wall surface boundary disposed in a space that is an analysis target are input; and
a processing unit that represents the fluid with a plurality of fluid particles and analyzes motions of the plurality of fluid particles on the basis of the information input to the input unit,
wherein the processing unit
obtains a contribution of a wall to a motion of each of the plurality of fluid particles by using the shape of the wall surface boundary and a spatial distribution of the plurality of fluid particles existing near the wall surface boundary, and
analyzes the motions of the plurality of fluid particles on the basis of the obtained contribution of the wall and contributions of other fluid particles for each of the plurality of fluid particles.

2. The simulation device according to claim 1,
wherein a continuity equation and an equation of motion for the fluid are used as governing equations when analyzing the motions of the plurality of fluid particles, and
when the contribution of the wall to the motion of each of the plurality of fluid particles is obtained,
a virtual wall is disposed at a position that is located on an extension line of a perpendicular line drawn from a computation target fluid particle to the wall surface boundary and at which a distance from the wall surface boundary is equal to a radius of the fluid particle, and
a velocity of the virtual wall in the governing equations is determined on the basis of a velocity of the computation target fluid particle and a distance from the computation target fluid particle to the wall surface boundary.

3. The simulation device according to claim 2,
wherein an orientation and a magnitude of a tangential component of the velocity of the virtual wall in the continuity equation, the tangential component being parallel to the wall surface boundary, are made equal to an orientation and a magnitude of a tangential component of the velocity of the computation target fluid particle,
an orientation of a normal component of the velocity of the virtual wall in the continuity equation, the normal component being perpendicular to the wall surface boundary, is opposite to an orientation of a normal component of the velocity of the computation target fluid particle,
a magnitude of the normal component of the velocity of the virtual wall in the continuity equation is made equal to the magnitude of the normal component of the velocity of a computation target fluid particle when the computation target fluid particle is in contact with the wall surface boundary, and is reduced in inverse proportion to the distance from the computation target fluid particle to the wall surface boundary as the computation target fluid particle becomes farther from the wall surface boundary,
an orientation of the tangential component of the velocity of the virtual wall in the equation of motion is opposite to the orientation of the tangential component of the velocity of the computation target fluid particle,
a magnitude of the tangential component of the velocity of the virtual wall in the equation of motion is made equal to the magnitude of the tangential component of the velocity of the computation target fluid particle when the computation target fluid particle is in contact with the wall surface boundary, and is reduced in inverse proportion to the distance from the computation target fluid particle to the wall surface boundary as the computation target fluid particle becomes farther from the wall surface boundary, and
an orientation and a magnitude of the normal component of the velocity of the virtual wall in the equation of motion are made equal to the orientation and the magnitude of the normal component of the velocity of the computation target fluid particle.

4. A simulation method using a particle method of analyzing a flow of a fluid by representing the fluid with a plurality of fluid particles and analyzing motions of the fluid particles, the simulation method comprising:
defining a shape of a wall surface boundary of a wall disposed in an analysis space;
obtaining a contribution of the wall to a motion of each of the plurality of fluid particles by using a shape of the wall surface boundary and a spatial distribution of the plurality of fluid particles existing near the wall surface boundary; and analyzing the motions of the plurality of fluid particles on the basis of the obtained contribution of the wall and contributions of other fluid particles for each of the plurality of fluid particles.

5. A computer readable medium storing a program that causes a computer to execute a process for analyzing a flow of a fluid by using a particle method, the process comprising:
acquiring information for defining the fluid to be analyzed, initial conditions and boundary conditions for analysis, and wall information for defining a shape of a wall surface boundary disposed in a space that is an analysis target;
representing the fluid with a plurality of fluid particles and analyzing motions of the plurality of fluid particles on the basis of the acquired information;
obtaining a contribution of a wall to a motion of each of the plurality of fluid particles by using the shape of the wall surface boundary and a spatial distribution of the plurality of fluid particles existing near the wall surface boundary; and analyzing the motions of the plurality of fluid particles on the basis of the obtained contribution of the wall and
contributions of other fluid particles for each of the plurality of fluid particles.
